(19) United States
(12) Patent Application Publication
(10) Pub. No.: US 2017/0343331 A1
(43) Pub. Date: Nov. 30, 2017

(54) DOUBLE SIDED MEASURING TAPE

(71) Applicant: Dennis E. Drury, Sr., West Alexandria, OH (US)

(72) Inventor: Dennis E. Drury, Sr., West Alexandria, OH (US)

(21) Appl. No.: 15/411,616

(22) Filed: Jan. 20, 2017

Related U.S. Application Data
(63) Continuation-in-part of application No. 29/565,688, filed on May 24, 2016, now abandoned.

(51) Int. Cl. G01B 3/10

(52) U.S. Cl. CPC G01B 3/1082; G01B 3/1041; G01B 2003/103

(57) ABSTRACT

A linear measuring device includes a tape housing and a semi-flexible measuring tape housed within the tape housing of a length L in a generally spiral configuration with an outer end extendable through a tape outlet opening and having a flange thereon. The tape having two sets of measurements, a first set displayed on a top side of the measuring tape with a first incremental measurement X, and second set displayed on a bottom side of the measuring tape with a first incremental measurement X+L.

This is a continuation-in-part which claims the benefit of an earlier filed U.S. application Ser. No. 29/565688 filed May 24, 2016.

### BACKGROUND OF THE INVENTION

### 1. Field of Invention

The present invention relates to tape measure devices and, more particularly, to a tape measure which includes a housing in which a flexible measuring tape having two distinct sets of measurement numbers or instantly providing internal or external measurements, depending on the measurement reading desired.

### 2. Description of the Prior Art

There are various types of measuring tapes. In many cases, internal measurements of openings, spaces, and objects must be made, and these measurements must be accurate to ensure that the proper fitting of materials is permitted. This is common in between drywall and replacement window industry involves the replacement insertion of cabinets or window replacement. In order to properly seat the item within the opening, extremely accurate measurements must be made, with the average tolerance about an ⅛ inch. If the measurement being made is significantly off, the item is required to be rebuilt or scrapped.

It is known that there is difficulty in measuring such internal openings. Several others have devised complicated or difficult to read measurement tapes to account for such measuring.

### SUMMARY OF THE INVENTION

It is an object of the present invention is to provide a double sided measuring tape.

Another object of the present invention is to provide a double sided measuring tape which may be quickly and easily used to measure both internal and external measurements of objects and openings.

Still another object of the present invention is to provide a double sided measuring tape which includes two separate and distinct sets of measurements displayed on opposing two and bottom sides of the measuring tape.

A further object of the present invention is to provide a double sided measuring tape which will eliminate the need for two separate measuring devices to be used for inner and outer measurements.

Finally, an object of the present invention is to provide a double sided measuring tape which is relatively simple and inexpensive to construct and is safe, efficient and durable in use.

Accordingly, the invention is directed to a linear measuring device includes a tape housing and a semi-flexible measuring tape housed within the tape housing of a length L in a generally spiral configuration with a forward flanged tongue section connected to, extending forwardly from an outer end of the measuring tape which extends through a tape outlet opening and has an inner end connected to an inner part within the housing. The tape has two sets of measurements, a first set displayed on a top side of the measuring tape with a first incremental measurement X adjacent said forward flanged tongue section, and second set displayed on a bottom side of the measuring tape with a first incremental measurement X+L adjacent said forward flanged tongue section.

When extended, the top side measurement displays the total extended distance of the measuring tape from the outer end of the measuring tape to the tape outlet opening equating to an outer length measurement of an object measured and a bottom side measurement of the two sets of measurements displays the total distance between total extended distance of the measuring tape from the outer end of the measuring tape to the tape outlet opening plus the length of the tape housing equating to an inner length measurement of an area between two opposing surfaces.

The present invention provides a substantial improvement over those inventions found in the prior art. For example, the design of the present invention permits the user to quickly and easily measure both external measurements and internal measurements and read the corresponding distance directly off of the measuring tape without additional structural tape components and having to add separate measurements together. The present invention is simple in design and manufacture, the cost for each unit is about as low as conventional tapes. The present invention thus provides a substantial improvement over those devices found in the prior art.

### BRIEF DESCRIPTION OF THE DRAWINGS

FIG. 1 is a perspective view of a DOUBLE SIDED MEASURING TAPE showing my new design;

FIG. 2 is a top view taken from DOUBLE SIDED MEASURING TAPE of FIG. 1 showing my new design;

FIG. 3 is a bottom perspective view of a DOUBLE SIDED MEASURING TAPE of FIG. 1 showing my new design;

FIG. 4 is a left side elevational view of a DOUBLE SIDED MEASURING TAPE of FIG. 1 showing my new design;

FIG. 5 is a right side elevational view of a DOUBLE SIDED MEASURING TAPE of FIG. 1 showing my new design;

FIG. 6 is a front side view of a DOUBLE SIDED MEASURING TAPE of FIG. 1 showing my new design; and

FIG. 7 is a back side elevational view of a DOUBLE SIDED MEASURING TAPE of FIG. 1 showing my new design.

### DESCRIPTION OF THE PREFERRED EMBODIMENT

Referring now to the drawings, the double sided measuring tape of the present invention is generally designated by the numeral 10. The double sided measuring tape includes a rigid plastic or metal housing 12 which encloses a generally semi-flexible metal or plastic measuring tape 14 and a locking mechanism 16. The housing 12, measuring tape 14, lock mechanism 16, and components thereof which enable the extension and retraction of measuring tape 14 from housing 12 function in a similar manner as those measuring tapes found in the prior art and therefore further discussion of the specific details of the operation of the extension, retraction, and locking elements of the measuring tape 14 of the double sided measuring tape 10 of the present invention will are understood to those skilled in the art. There are numerous modifications, variations and derivations as to the locking mechanisms of measuring tapes in the prior art which are within the scope of the instant invention.

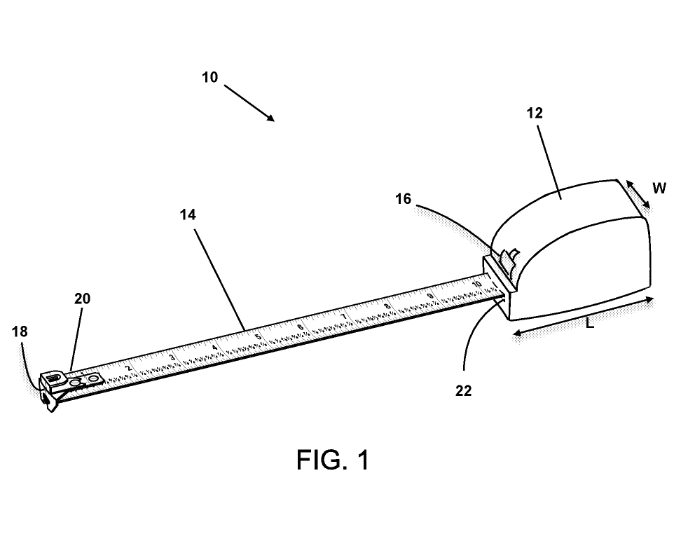

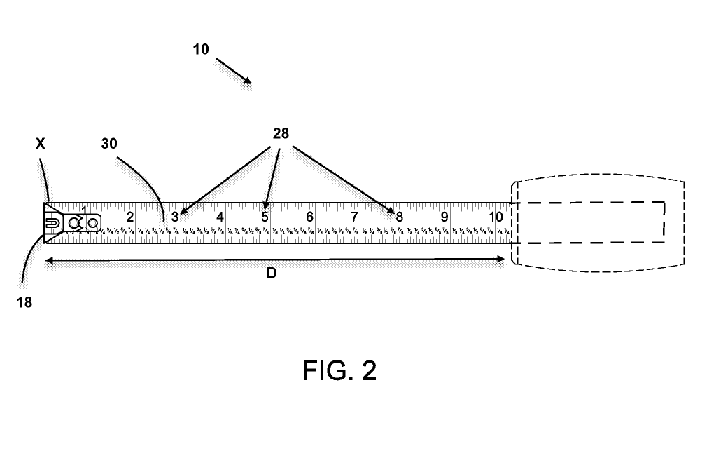

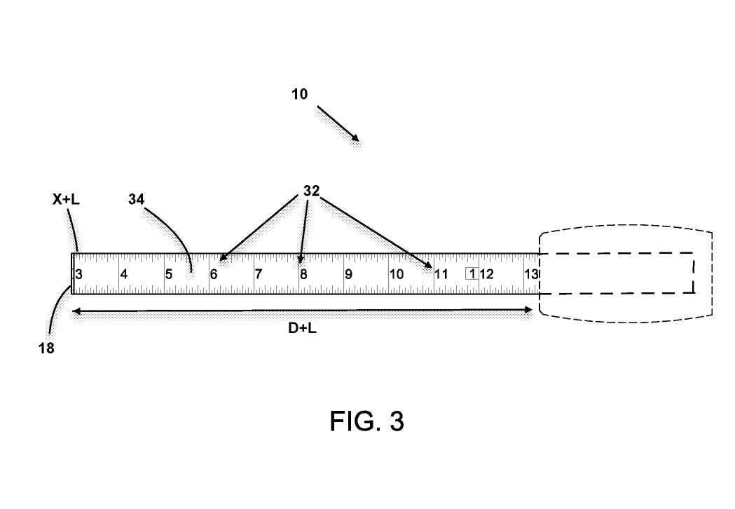

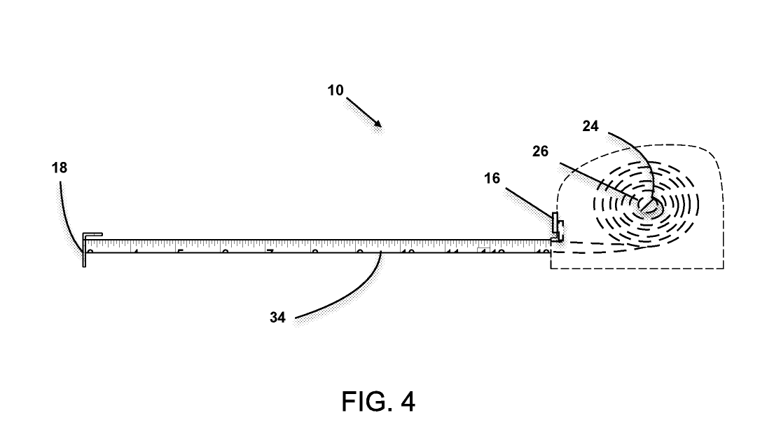

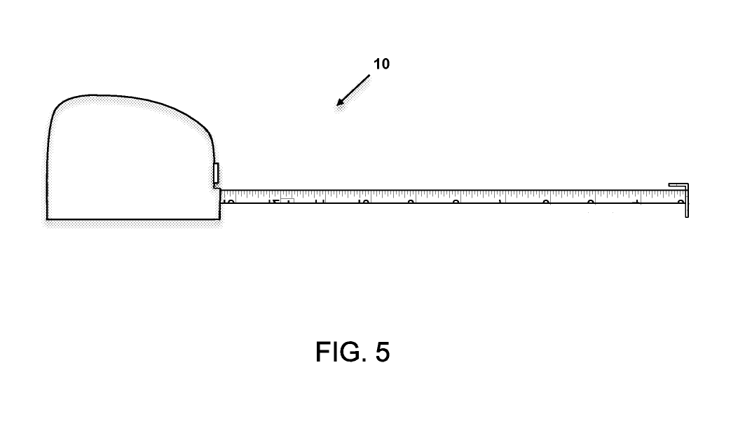

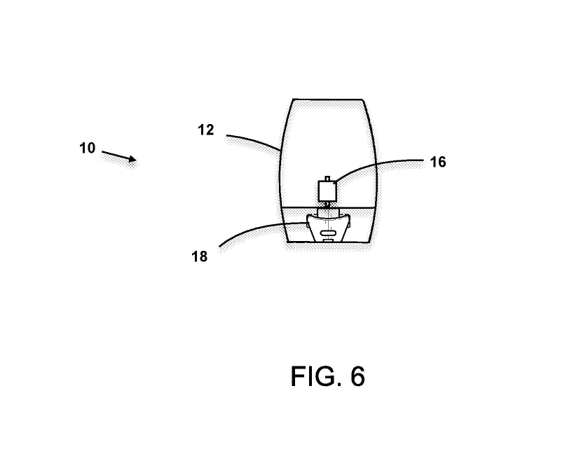

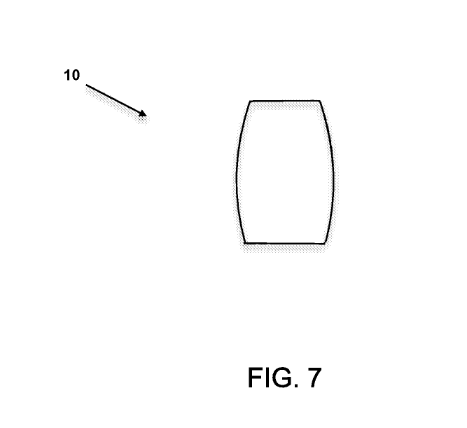

The key inventive features of the present invention are described as follows and are shown best in FIGS. 1-7. The length of the housing 12 has a length L, for example, of approximately one to three inches and a width W approximately equal to the width of measuring tape 14. The measuring tape 14 is housed within the tape housing 12 in a generally spiral configuration with biasing means, such as a spring for permitting extension and retraction. A forward flanged tongue section 18 is connected to and extending forwardly from an outer end 20 of the measuring tape 14 which extends through a tape outlet opening 22 of housing 12. An inner end 24 is connected to an inner biasing mechanism 26 within the housing 12. The tape 14 has two sets of measurements, and in this exemplary embodiment provides a first set 28 displayed on a top side 30 of the measuring tape 14 with a first incremental measurement X adjacent said forward flanged tongue section 18, and second set 32 displayed on a bottom side 34 of the measuring tape with a first incremental measurement X+L adjacent said forward flanged tongue section 18.

The top side measurement displaying the total extended distance of the measuring tape 14 from the outer end 20 of the measuring tape to the tape outlet opening 22 a distance “D” and a bottom side measurement of the two sets of measurements displaying the total distance between total extended distance of the measuring tape 14 from the outer end 20 of the measuring tape to the tape outlet opening 22 a distance D+L equating to an inner measurement of an area between two opposing surfaces.

Prior measuring tapes include only a single series of numbers and provide the distance from the forward end of measuring tape or include a cumbersome rearward section to include for measuring within pockets or between opposing drywall surfaces. Those tapes are less desirable than the instant invention. The present invention solves the problem of internal measurement as well as external measurement by providing the double sided measuring tape 10. External measurement top side 30 includes a series of measurement numbers generally familiar to users of measuring tape devices which measure the distance from the measuring tape forward flanged tongue section 18 rearwards towards the housing 12 tape outlet opening 22. The internal measurement bottom side 34, however, provides a measurement reading which incorporates the length of measuring from forward flanged tongue section 18 rearwards, plus the length of housing 12 added together and printed as the internal measurement bottom side 34, and thus the measurement reading shown on internal measurement bottom side 34 provides a simple, quick, and effective measurement of the internal dimensions of the recess, object, or area being measured. Prior art tapes require cumbersome or more expensive constructed devices. The double sided measuring tape 10 of the present invention eliminates the need for such other devices and calculations by providing a simple, quick, and effective internal measurement reading taken directly from the internal measurement bottom side 34 of measuring tape 14.

It is to be understood that numerous additions, modifications, and derivations may be made to the double sided measuring tape 10 of the present invention which fall within the intended scope of the above description. The configuration and construction materials used in connection with the double sided measuring tape 10 may be modified or changed so long as the intended functionality is neither degraded nor destroyed. The unit lengths and system of marking can be of metric or U.S. standard. There has therefore been shown and described a double sided measuring tape 10 which accomplishes at least all of its intended objectives.

1. A measuring tape, which includes;
a housing of a length L and having a tape outlet opening,
a flexible tape operably connected to said housing to permit extension and retraction therefrom in a generally spiral configuration with an outer end extendable through said tape outlet opening and having a forward flanged tongue section thereon, said tape having two sets of measurements, a first set displayed on a top side of said measuring tape with a first incremental measurement X adjacent said forward flanged tongue section, and second set displayed on a bottom side of said measuring tape with a first incremental measurement X+L adjacent said forward flanged tongue section and directly beneath said first incremental measurement on said top side, and
a lock mechanism connected to said housing which enables extension, retraction, and locking of said flexible tape.

2. The measuring tape of claim 1, wherein when said tape is extended, a top side measurement displays total extended distance of the measuring tape from said outer end to said tape outlet opening a distance D and a bottom side measurement displays the total distance between total extended distance of said measuring tape from said outer end to said tape outlet opening a distance D+L.

3. The measuring tape of claim 1, wherein when said tape is double sided and said first set is displayed on a top side of the measuring tape and said second set is displayed on a bottom side of said measuring tape.

4. A double sided measuring tape, which includes;
a housing of a length L and having a tape outlet opening,
a flexible tape operably connected to said housing to permit extension and retraction therefrom in a generally spiral configuration with an outer end extendable through said tape outlet opening and having a forward flanged tongue section thereon, said tape having two sets of measurements, a first set displayed on a top side of the measuring tape with a first incremental measurement X adjacent said forward flanged tongue section, and second set displayed on a bottom side of the measuring tape with a first incremental measurement X+L adjacent said forward flanged tongue section and directly beneath said first incremental measurement on said top side, and
a lock mechanism connected to said housing which enables extension, retraction, and locking of said flexible tape.

5. The double sided measuring tape of claim 4, wherein when said tape is extended, a top side measurement displays total extended distance of the measuring tape from said outer end to said tape outlet opening a distance D and a bottom side measurement displays the total distance between total extended distance of said measuring tape from said outer end to said tape outlet opening a distance D+L.
